(19) United States
(12) Patent Application Publication
(10) Pub. No.: US 2022/0230258 A1
(43) Pub. Date: Jul. 21, 2022

(54) METHOD AND SYSTEM FOR DETERMINING COLLISIONS BETWEEN REAL ESTATE RECORDS, INCLUDING FOR PREDICTING TERMINATION OR NON-RENEWAL OF EVALUATED REAL ESTATE LEASES

(71) Applicant: OKAPI EMAAS LTD., Rosh Haayen (IL)

(72) Inventor: Ailon Velger, Rehovot (IL)

(21) Appl. No.: 17/151,178

(22) Filed: Jan. 17, 2021

(51) Int. Cl. G06Q 50/16; G06N 20/00; G06F 17/18

(52) U.S. Cl. CPC G06Q 50/16; G06F 17/18; G06N 20/00

(57) ABSTRACT

A method for determining that a given real estate record (RER) and at least one other RER of one or more other RERs are successive events associated with a common real estate resource, the method comprising: providing one or more statistical distribution functions (SDFs) or machine learning (ML) models; obtaining resource information on resource features that are associated with the one or more real estate resources and RER information on record features that are associated with the given RER and the other RERs; calculating a collision probability that the given RER and the at least one other RER are the successive events, based on the resource information, the RER information, and one or more of the SDFs or ML models; and determining, upon the collision probability being greater than or equal to a given probability, that the given RER and the at least one other RER are the successive events.

### TECHNICAL FIELD

The invention relates to a method and system for determining collisions between real estate records, including for predicting termination or non-renewal of evaluated real estate leases.

### BACKGROUND

Publicly and commercially available information on real estate records (e.g., real estate leases, real estate listings, real estate sales contracts, etc.) that are associated with real estate transactions (e.g., real estate rentals, real estate sales, etc.) can be incomplete and/or inaccurate. Accordingly, two real estate records may be associated with a common real estate space (i.e., may collide), yet, due to incomplete and/or inaccurate information on the real estate records, this association may not be known.

To illustrate this, attention is now drawn to Table I below.

TABLE I

| Lease | Floor | Suite | Rent | Size | Start Date | End Date |
|---|---|---|---|---|---|---|
| AA | 5 | ? | $$$ | 5,000 SQFT | January 2014 | January 2020 |
| BB | ? | ? | $ | 3,400 SQFT | January 2013 | January 2023 |
| CC | ? | ? | $$ | 5,000 SQFT | February 2015 | February 2018 |
| DD | ? | ? | $$$ | 3,200 SQFT | May 2014 | May 2034 |
| EE | 8 | 80 | $$ | 10,250 SQFT | February 2015 | May 2029 |
| . . . | | | | | | |
| XX | ? | ? | $$$ | 3,333 SQFT | June 2016 | June 2026 |
| YY | ? | ? | $$$$ | 5,000 SQFT | May 2017 | June 2022 |
| ZZ | ? | ? | $$ | 6,500 SQFT | May 2017 | July 2029 |

Table I illustrates an example database of real estate leases, the real estate leases being associated with real estate units in a given building. For many of the real estate leases, information is lacking on the real estate units that are associated with the respective real estate leases.

In view of the foregoing, there is a need for a new method and system for determining collisions between real estate records (i.e., for determining an association of the real estate records with a common real estate space), notwithstanding incomplete and/or inaccurate information on the real estate records.

References considered to be relevant as background to the presently disclosed subject matter are listed below. Acknowledgement of the references herein is not to be inferred as meaning that these are in any way relevant to the patentability of the presently disclosed subject matter.

U.S. Patent Application Publication No. 2020/0334744, published on Oct. 22, 2020, discloses a system that may include a rental unit allocation portal and a prediction unit. The portal receives tenant application information and allocates a rental unit based on the tenant application information and a length of stay prediction score associated with the tenant. The prediction unit may determine the length of stay prediction score by using one or more models and voting among the prediction scores of the one or more models. The one or more models may include a logic regression model, a survival analysis model, a tree-based model and/or a gradient boosting model. In addition, the system may include a conformal predictor configured to predict the confidence interval. The length of stay prediction score can also be provided to a risk allocation unit configured to quantify risk by aggregating it for a portfolio of underlying properties with tenants, or a portfolio of loans secured by tenanted properties.

AlteryxAdvocacy, Alteryx Community—Analytics in Commercial Real Estate at CBRE, retrieved at https://community.alteryx.com/t5/tkb/articleprintpage/tkb-id/use-cases/article-id/729 on Oct. 29, 2020, discloses a model based on historical data to predict the likelihood of lease renewals for building tenants.

Hans Christian Ekne, “Data Science for Real. Transforming Property Management with Advanced Analytics and Machine Learning”, Towards Data Science, Nov. 30, 2018, retrieved at https://towardsdatascience.com/data-science-for-real-c09f088b6550 on Oct. 29, 2020, discloses a churn model that can be used to predict the probability that a tenant will leave a rented unit within a given time frame, for example 1 year. Armed with this knowledge a property manager can better understand how the tenant mix will change over time and which units are likely to become available soon. In addition, the model can highlight which units likely will need to be filled in the future, so that the vacancy period of a unit can reduced.

Japanese Patent Application Publication No. 2015/191648, published on Nov. 2, 2015, discloses a distribution analysis function that creates rent distribution data, vacancy rate distribution data, and turnover rate distribution data indicating a turnover rate of a lease contract, from rental real estate recruitment data in a wide area including a location of evaluation object property and for a predetermined period traced back to the past. A function of calculating a rent and a vacancy rate extracts data equivalent to property information and access information of the evaluation object property from the rent distribution data and the vacancy rate distribution data to calculate a rent and a vacancy rate of the evaluation object property. An operation income calculation function calculates an operation income according to the calculated rent and vacancy rate of the evaluation object property. An operation payment calculation function extracts data equivalent to the property information from the turnover rate distribution data to calculate an operation payment for the evaluation object property. A profit calculation function calculates a profit of the evaluation object property from the operation income, the operation payment and a yield.

U.S. Patent Application Publication No. 2013/0304655, published on Nov. 14, 2013, discloses a system for using real estate lease data having at least one property file stored on a data storage device and representing a property that has at least one leasable space, and a lease deal component operated by at least one processor and receiving data for a plurality of lease deals each with terms of a lease deal. At least one previously established lease deal has data for a lease deal, and is associated to at least one leasable space. This lease deal was established previously to at least one subsequent lease deal. The lease deal component links at least one subsequent lease deal to the at least one previously established lease deal to associate the at least one subsequent lease deal with an amount of leasable space linked to the previously established lease deal. A display displays lease terms or results of financial calculations or both of at least one linked lease deal.

U.S. Patent Application Publication No. 2014/0365339, published on Dec. 11, 2014, discloses a method for providing service users with occupancy cost comparisons between a plurality of commercial leased properties includes the steps of: (a) defining an occupancy cost parameter for a leased property, (b) providing an interface for service users to input into a searchable database the identifying property information and the specific lease terms required to compute this occupancy cost parameter for each of the leased properties, (c) providing an algorithm that utilizes the inputted specific lease terms information to compute the occupancy cost parameter for each of the leased properties, (d) utilizing the occupancy cost parameters to create a fiduciary-responsibility-abiding (FRA) lease comp for each of the leased properties, and (e) storing in the database the FRA lease comp for each of the leased properties.

### General Description

In accordance with a first aspect of the presently disclosed subject matter, there is provided a method for determining that a given real estate record and at least one other real estate record of one or more other real estate records, other than the given real estate record, are actual successive events associated with a common real estate resource, the common real estate resource being one of one or more real estate resources for which the given real estate record and at least one of the other real estate records are possible successive events, the method comprising: providing one or more statistical distribution functions or machine learning (ML) models, the statistical distribution functions or ML models being generated based on entry information that is included in multiple pairs of ground truth real estate entries; obtaining: (a) resource information on resource features that are associated with the one or more real estate resources; (b) given real estate record information on given record features that are associated with the given real estate record; and (c) other real estate record information on other record features that are associated with the other real estate records; calculating a common real estate resource collision probability that the given real estate record and the at least one other real estate record are the actual successive events associated with the common real estate resource, the common real estate resource collision probability being calculated based on the resource information, the given real estate record information, the other real estate record information, and one or more of the statistical distribution functions or ML models; comparing the common real estate resource collision probability to a given probability; and upon the common real estate resource collision probability being greater than or equal to the given probability, determining that the given real estate record and the at least one other real estate record are the actual successive events associated with the common real estate resource.

In some cases, a first start date of the given real estate record is earlier than second start dates of the other real estate records.

In some cases, the second start dates are within a predefined date range subsequent to the first start date.

In some cases, the given real estate record is associated with a given real estate lease; the other real estate records are associated with one or more other real estate leases; the second start dates are earlier than or concurrent to a record end date of the given real estate record, and wherein determining that the given real estate record and the at least one other real estate record are the actual successive events associated with the common real estate resource is indicative of a termination or a non-renewal of the given real estate lease.

In some cases, determining that the given real estate record and the at least one other real estate record are the actual successive events associated with the common real estate resource is indicative of the termination or the non-renewal of the given real estate lease upon a second start date associated with the at least one other real estate record being earlier than the record end date of the given real estate record by at least a predetermined threshold time.

In some cases, the common real estate resource collision probability is calculated as follows: for each real estate resource of the one or more real estate resources: (a) determining a record-resource probability that the given real estate record is associated with the respective real estate resource; and (b) for each other real estate record of the other real estate records, determining a conditional probability that the respective other real estate record is not associated with the respective real estate resource, provided that the given real estate record is associated with the respective real estate resource, thereby providing one or more conditional probabilities that are associated with the other real estate records; calculating a non-collision probability that the given real estate record and none of the other real estate records are the actual successive events associated with the common real estate resource, based on the record-resource probability and the conditional probabilities that are determined for each real estate resource of the one or more real estate resources; and subtracting the non-collision probability from a one-hundred percent probability.

In some cases, the non-collision probability is calculated as follows: for each real estate resource of the one or more real estate resources, calculating a product of the record-resource probability that is determined for the respective real estate resource and a sum of the conditional probabilities that are determined for the respective real estate resource, thereby providing one or more calculated products corresponding to the one or more real estate resources; and if the one or more real estate resources are two or more real estate resources, combining the calculated products.

In some cases, the calculated products are combined by adding the calculated products.

In some cases, the common real estate resource collision probability is calculated as follows: for each real estate resource of the one or more real estate resources: (a) determining a record-resource probability that the given real estate record is associated with the respective real estate resource; (b) for each other real estate record of the other real estate records, determining a conditional probability that the respective other real estate record is associated with the respective real estate resource, provided that the given real estate record is associated with the respective real estate resource, thereby providing one or more conditional probabilities that are associated with the other real estate records; and (c) calculating a product of the record-resource probability that is determined for the respective real estate resource and a sum of the conditional probabilities that are provided for the respective real estate resource, thereby providing one or more calculated products corresponding to the one or more real estate resources; and if the one or more real estate resources are two or more real estate resources, combining the calculated products.

In some cases, the calculated products are combined by adding the calculated products.

In some cases, the given probability is a predetermined probability or is dynamically calculated.

In some cases, the given real estate record is a given real estate lease, a given real estate rental listing, or a given real estate sales record.

In some cases, the other real estate records include at least one of: (a) one or more other real estate leases, (b) one or more other real estate rental listings, or (c) one or more other real estate sales records.

In some cases, the given real estate record is a Commercial Real Estate (CRE) record, the other real estate records are CRE records, and the real estate resources are commercial real estate resources.

In accordance with a second aspect of the presently disclosed subject matter, there is provided a method for predicting a termination or a non-renewal of an evaluated real estate lease, the method comprising: obtaining a data repository comprising a plurality of real estate records, each real estate record of the real estate records: (a) being associated with a real estate lease, and (b) including a target field that indicates whether the real estate lease has been terminated or not renewed, wherein, for a given real estate record of the real estate records, an indication of a termination or a non-renewal of a given real estate lease that is associated with the given real estate record is determined upon calculating a common real estate resource collision probability greater than or equal to a given probability and less than a one-hundred percent probability that the given real estate record and at least one other real estate record are actual successive events associated with a common real estate resource, in accordance with the first aspect of the presently disclosed subject matter, wherein a first start date of the given real estate record is earlier than a second start date of the at least one other real estate record, the second start date being earlier than or concurrent to a record end date of the given real estate record, or earlier than the record end date of the given real estate record by at least a predetermined threshold time; training one or more Machine Learning (ML) models based on the real estate records in the data repository; and predicting, using at least one of the ML models, the termination or the non-renewal of the evaluated real estate lease.

In some cases, the evaluated real estate lease is a Commercial Real Estate (CRE) lease, and the real estate records are CRE records.

In accordance with a third aspect of the presently disclosed subject matter, there is provided a system for determining that a given real estate record and at least one other real estate record of one or more other real estate records, other than the given real estate record, are actual successive events associated with a common real estate resource, the common real estate resource being one of one or more real estate resources for which the given real estate record and at least one of the other real estate records are possible successive events, the system comprising a processing circuitry configured to: provide one or more statistical distribution functions or machine learning (ML) models, the statistical distribution functions or ML models being generated based on entry information that is included in multiple pairs of ground truth real estate entries; obtain: (a) resource information on resource features that are associated with the one or more real estate resources; (b) given real estate record information on given record features that are associated with the given real estate record; and (c) other real estate record information on other record features that are associated with the other real estate records; calculate a common real estate resource collision probability that the given real estate record and the at least one other real estate record are the actual successive events associated with the common real estate resource, the common real estate resource collision probability being calculated based on the resource information, the given real estate record information, the other real estate record information, and one or more of the statistical distribution functions or ML models; compare the common real estate resource collision probability to a given probability; and upon the common real estate resource collision probability being greater than or equal to the given probability, determine that the given real estate record and the at least one other real estate record are the actual successive events associated with the common real estate resource.

In some cases, a first start date of the given real estate record is earlier than second start dates of the other real estate records.

In some cases, the second start dates are within a predefined date range subsequent to the first start date.

In some cases, the given real estate record is associated with a given real estate lease; the other real estate records are associated with one or more other real estate leases; the second start dates are earlier than or concurrent to a record end date of the given real estate record, and wherein determining that the given real estate record and the at least one other real estate record are the actual successive events associated with the common real estate resource is indicative of a termination or a non-renewal of the given real estate lease.

In some cases, determining that the given real estate record and the at least one other real estate record are the actual successive events associated with the common real estate resource is indicative of the termination or the non-renewal of the given real estate lease upon a second start date associated with the at least one other real estate record being earlier than the record end date of the given real estate record by at least a predetermined threshold time.

In some cases, the processing circuitry is configured to calculate the common real estate resource collision probability as follows: for each real estate resource of the one or more real estate resources, the processing circuitry is configured to: (a) determine a record-resource probability that the given real estate record is associated with the respective real estate resource; and (b) for each other real estate record of the other real estate records, determine a conditional probability that the respective other real estate record is not associated with the respective real estate resource, provided that the given real estate record is associated with the respective real estate resource, thereby providing one or more conditional probabilities that are associated with the other real estate records; calculate a non-collision probability that the given real estate record and none of the other real estate records are the actual successive events associated with the common real estate resource, based on the record-resource probability and the conditional probabilities that are determined for each real estate resource of the one or more real estate resources; and subtract the non-collision probability from a one-hundred percent probability.

In some cases, the processing circuitry is configured to calculate the non-collision probability as follows: for each real estate resource of the one or more real estate resources, the processing circuitry is configured to calculate a product of the record-resource probability that is determined for the respective real estate resource and a sum of the conditional probabilities that are determined for the respective real estate resource, thereby providing one or more calculated products corresponding to the one or more real estate resources; and if the one or more real estate resources are two or more real estate resources, the processing circuitry is configured to combine the calculated products.

In some cases, the processing circuitry is configured to combine the calculated products by adding the calculated products.

In some cases, the processing circuitry is configured to calculate the common real estate resource collision probability as follows: for each real estate resource of the one or more real estate resources, the processing circuitry is configured to: (a) determine a record-resource probability that the given real estate record is associated with the respective real estate resource; (b) for each other real estate record of the other real estate records, determine a conditional probability that the respective other real estate record is associated with the respective real estate resource, provided that the given real estate record is associated with the respective real estate resource, thereby providing one or more conditional probabilities that are associated with the other real estate records; and (c) calculate a product of the record-resource probability that is determined for the respective real estate resource and a sum of the conditional probabilities that are provided for the respective real estate resource, thereby providing one or more calculated products corresponding to the one or more real estate resources; and if the one or more real estate resources are two or more real estate resources, the processing circuitry is configured to combine the calculated products.

In some cases, the processing circuitry is configured to combine the calculated products by adding the calculated products.

In some cases, the given probability is a predetermined probability or is dynamically calculated.

In some cases, the given real estate record is a given real estate lease, a given real estate rental listing, or a given real estate sales record.

In some cases, the other real estate records include at least one of: (a) one or more other real estate leases, (b) one or more other real estate rental listings, or (c) one or more other real estate sales records.

In some cases, the given real estate record is a Commercial Real Estate (CRE) record, the other real estate records are CRE records, and the real estate resources are commercial real estate resources.

In accordance with a fourth aspect of the presently disclosed subject matter, there is provided a system for predicting a termination or a non-renewal of an evaluated real estate lease, the system comprising a processing circuitry configured to: obtain a data repository comprising a plurality of real estate records, each real estate record of the real estate records: (a) being associated with a real estate lease, and (b) including a target field that indicates whether the real estate lease has been terminated or not renewed, wherein, for a given real estate record of the real estate records, an indication of a termination or a non-renewal of a given real estate lease that is associated with the given real estate record is determined upon calculating a common real estate resource collision probability greater than or equal to a given probability and less than a one-hundred percent probability that the given real estate record and at least one other real estate record are actual successive events associated with a common real estate resource, in accordance with the third aspect of the presently disclosed subject matter, wherein a first start date of the given real estate record is earlier than a second start date of the at least one other real estate record, the second start date being earlier than or concurrent to a record end date of the given real estate record, or earlier than the record end date of the given real estate record by at least a predetermined threshold time; train one or more Machine Learning (ML) models based on the real estate records in the data repository; and predict, using at least one of the ML models, the termination or the non-renewal of the evaluated real estate lease.

In some cases, the evaluated real estate lease is a Commercial Real Estate (CRE) lease, and the real estate records are CRE records.

In accordance with a fifth aspect of the presently disclosed subject matter, there is provided a non-transitory computer readable storage medium having computer readable program code embodied therewith, the computer readable program code, executable by a processing circuitry of a computer to perform a method for determining that a given real estate record and at least one other real estate record of one or more other real estate records, other than the given real estate record, are actual successive events associated with a common real estate resource, the common real estate resource being one of one or more real estate resources for which the given real estate record and at least one of the other real estate records are possible successive events, the method comprising: providing one or more statistical distribution functions or machine learning (ML) models, the statistical distribution functions or ML models being generated based on entry information that is included in multiple pairs of ground truth real estate entries; obtaining: (a) resource information on resource features that are associated with the one or more real estate resources; (b) given real estate record information on given record features that are associated with the given real estate record; and (c) other real estate record information on other record features that are associated with the other real estate records; calculating a common real estate resource collision probability that the given real estate record and the at least one other real estate record are the actual successive events associated with the common real estate resource, the common real estate resource collision probability being calculated based on the resource information, the given real estate record information, the other real estate record information, and one or more of the statistical distribution functions or ML models; comparing the common real estate resource collision probability to a given probability; and upon the common real estate resource collision probability being greater than or equal to the given probability, determining that the given real estate record and the at least one other real estate record are the actual successive events associated with the common real estate resource.

In accordance with a sixth aspect of the presently disclosed subject matter, there is provided a non-transitory computer readable storage medium having computer readable program code embodied therewith, the computer readable program code, executable by a processing circuitry of a computer to perform a method for predicting a termination or a non-renewal of an evaluated real estate lease, the method comprising: obtaining a data repository comprising a plurality of real estate records, each real estate record of the real estate records: (a) being associated with a real estate lease, and (b) including a target field that indicates whether the real estate lease has been terminated or not renewed, wherein, for a given real estate record of the real estate records, an indication of a termination or a non-renewal of a given real estate lease that is associated with the given real estate record is determined upon calculating a common real estate resource collision probability greater than or equal to a given probability and less than a one-hundred percent probability that the given real estate record and at least one other real estate record are actual successive events associated with a common real estate resource, in accordance with the first aspect of the presently disclosed subject matter, wherein a first start date of the given real estate record is earlier than a second start date of the at least one other real estate record, the second start date being earlier than or concurrent to a record end date of the given real estate record, or earlier than the record end date of the given real estate record by at least a predetermined threshold time; training one or more Machine Learning (ML) models based on the real estate records in the data repository; and predicting, using at least one of the ML models, the termination or the non-renewal of the evaluated real estate lease.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a block diagram schematically illustrating one example of a collision determination system, in accordance with the presently disclosed subject matter;

FIG. 2 is a flowchart illustrating one example of a sequence of operations performed by the collision determination system to determine a collision between real estate records, in accordance with the presently disclosed subject matter;

FIG. 3 is a schematic diagram illustrating a first example of a sequence of operations for calculating a common real estate resource collision probability that a given real estate record and at least one other real estate record are actual successive events associated with a common real estate resource, in accordance with the presently disclosed subject matter;

FIG. 4 is a schematic diagram illustrating a second example of a sequence of operations for calculating a common real estate resource collision probability that a given real estate record and at least one other real estate record are actual successive events associated with a common real estate resource, in accordance with the presently disclosed subject matter;

FIG. 5 is a flowchart illustrating one example of a sequence of operations for providing one or more statistical distribution functions for calculating the common real estate resource collision probability, in accordance with the presently disclosed subject matter;

FIG. 6 is a flowchart illustrating one example of a sequence of operations for calculating the likelihood of a collision between new real estate entries, based on the statistical distribution functions that are calculated in FIG. 5, in accordance with the presently disclosed subject matter;

FIG. 7 is a flowchart illustrating one example of a sequence of operations for determining a likelihood of a collision between a new pair of new real estate entries, based on at least one Machine Learning (ML) model, in accordance with the presently disclosed subject matter;

FIG. 8 is a flowchart illustrating one example of a sequence of operations for dynamically calculating a given probability, in accordance with the presently disclosed subject matter;

FIG. 9 is a block diagram schematically illustrating one example of a collision prediction system, in accordance with the presently disclosed subject matter; and

FIG. 10 is a flowchart illustrating one example of a sequence of operations performed by the collision prediction system, in accordance with the presently disclosed subject matter.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, and components have not been described in detail so as not to obscure the presently disclosed subject matter.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “providing”, “obtaining”, “calculating”, “comparing”, “determining”, “indicating”, “subtracting”, “combining”, “adding”, “training”, “predicting” or the like, include actions and/or processes, including, inter alia, actions and/or processes of a computer, that manipulate and/or transform data into other data, said data represented as physical quantities, e.g. such as electronic quantities, and/or said data representing the physical objects. The terms “computer”, “processor”, “processing circuitry” and “controller” should be expansively construed to cover any kind of electronic device with data processing capabilities, including, by way of non-limiting example, a personal desktop/laptop computer, a server, a computing system, a communication device, a smartphone, a tablet computer, a smart television, a processor (e.g. digital signal processor (DSP), a microcontroller, a field programmable gate array (FPGA), an application specific integrated circuit (ASIC), etc.), a group of multiple physical machines sharing performance of various tasks, virtual servers co-residing on a single physical machine, any other electronic computing device, and/or any combination thereof.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

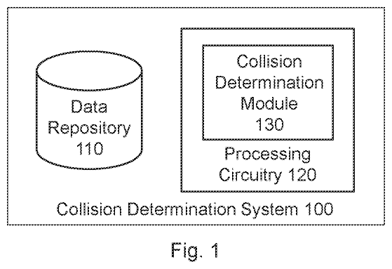

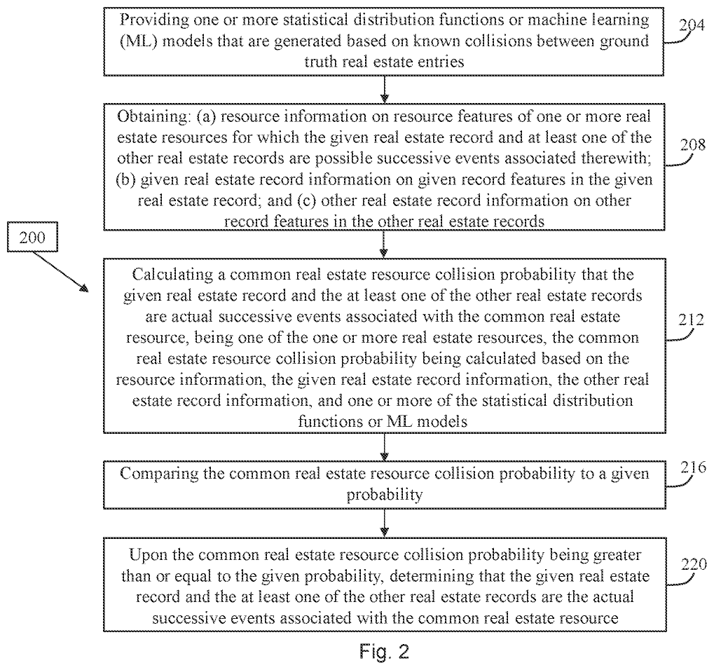

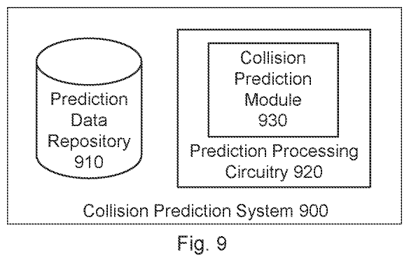

In embodiments of the presently disclosed subject matter, fewer, more and/or different stages than those shown in FIGS. 2 to 8 and 10 may be executed. FIGS. 1 and 9 illustrate a general schematic of the system architecture in accordance with an embodiment of the presently disclosed subject matter. Each module in FIGS. 1 and 9 can be made up of any combination of software, hardware and/or firmware that performs the functions as defined and explained herein. The modules in FIGS. 1 and 9 may be centralized in one location or dispersed over more than one location. In other embodiments of the presently disclosed subject matter, the system may comprise fewer, more, and/or different modules than those shown in FIGS. 1 and 9.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Bearing this is mind, attention is now drawn to FIG. 1, a block diagram schematically illustrating one example of a collision determination system 100, in accordance with the presently disclosed subject matter.

In accordance with the presently disclosed subject matter, collision determination system 100 can comprise or be otherwise associated with a data repository 110 (e.g. a database, a storage system, a memory including Read Only Memory—ROM, Random Access Memory—RAM, or any other type of memory, etc.) configured to store data. The data stored can include (a) one or more statistical distribution functions or machine learning (ML) models, (b) resource information and (c) real estate record information. In some cases, data repository 110 can be further configured to enable retrieval and/or update and/or deletion of the stored data. It is to be noted that in some cases, data repository 110 can be distributed.

Collision determination system 100 also comprises a processing circuitry 120. Processing circuitry 120 can be one or more processing units (e.g. central processing units), microprocessors, microcontrollers (e.g. microcontroller units (MCUs)) or any other computing devices or modules, including multiple and/or parallel and/or distributed processing units, which are adapted to independently or cooperatively process data for controlling relevant collision determination system 100 resources and for enabling operations related to collision determination system 100 resources.

Processing circuitry 120 can be configured to include a collision determination module 130. Processing circuitry 120 can be configured, e.g. using collision determination module 130, to determine that a given real estate record and at least one other real estate record of one or more other real estate records, other than the given real estate record, are successive events associated with a common real estate resource (e.g., common real estate space), as detailed further herein, inter alia with reference to FIGS. 2 to 4 and 6 to 8. That is, processing circuitry 120 can be configured to determine that the at least one other real estate record directly continues (i.e., collides with) the given real estate record on the common real estate resource. The common real estate resource is one of one or more real estate resources for which the given real estate record and at least one of the other real estate records are possibly successive events associated therewith.

In some cases, the real estate resources can be residential real estate spaces, for example, apartment units, condominiums, detached homes, semi-detached homes, residential buildings, etc. Alternatively, in some cases, the real estate resources can be Commercial Real Estate (CRE) spaces that are used for commercial (e.g., office/retail/medical/industrial/hospitality/etc.) activity, for example, commercial suites within a building, other commercial units that are used for commercial activity, commercial buildings, etc.

In some cases, the real estate records can be real estate rental records that are associated with rented real estate resources (e.g., rented real estate spaces). A respective real estate rental record of the real estate rental records can be, for example, a real estate lease or a real estate rental listing that is associated with a real estate lease. Moreover, the respective real estate rental record can be associated with, for example, a short term rental, a standard term rental, or a long term rental. In addition, in some cases, the respective real estate rental record can be associated with a rented real estate resource that is rented for residential use or as a storage space for individuals. Alternatively, in some cases, the respective real estate rental record can be a Commercial Real Estate (CRE) record that is associated with a rented real estate resource that is rented for commercial use.

In some cases, the real estate records can be real estate sales records that are associated with sales of real estate resources (e.g., real estate spaces). A respective real estate sales record can be, for example, a real estate sales contract, a real estate title deed (i.e., a public record of the real estate sale), or a real estate sales listing. In some cases, the respective real estate sales record can be associated with a residential real estate space, e.g. a space to be used as a residence. Alternatively, in some cases, the respective real estate sales record can be a Commercial Real Estate (CRE) record that is associated with a CRE space that is used for commercial activity.

Attention is now drawn to FIG. 2, a flowchart illustrating one example of a sequence of operations 200 performed by collision determination system 100 to determine a collision between real estate records, in accordance with the presently disclosed subject matter.

In accordance with the presently disclosed subject matter, collision determination system 100 can be configured, e.g. using collision determination module 130, to determine that a given real estate record and at least one other real estate record of one or more other real estate records, other than the given real estate record, are successive events associated with a common real estate resource (e.g., common real estate space), the common real estate resource being defined earlier herein, inter alia with reference to FIG. 1. Put differently, collision determination system 100 can be configured to determine a collision between the given real estate record and at least one other real estate record. A corollary of this is that based only on known (e.g., publicly or commercially available) information regarding the given real estate record and the other real estate records, the collision between the given real estate record and the at least one other real estate record is possible but cannot be determined.

In some cases, the common real estate resource can be a specific real estate resource. For example, in the event that the real estate resource with which the given real estate record is associated is known, a collision between the given real estate record and at least one other real estate record will be associated with this real estate resource.

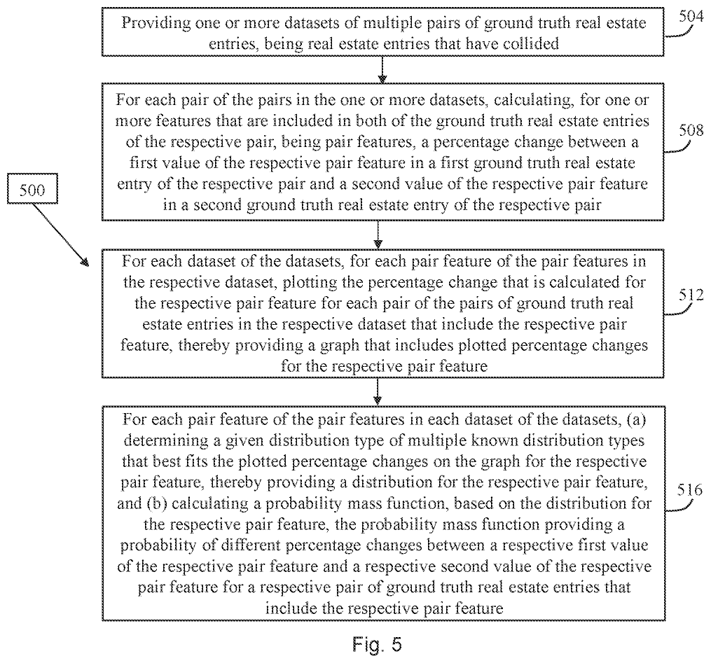

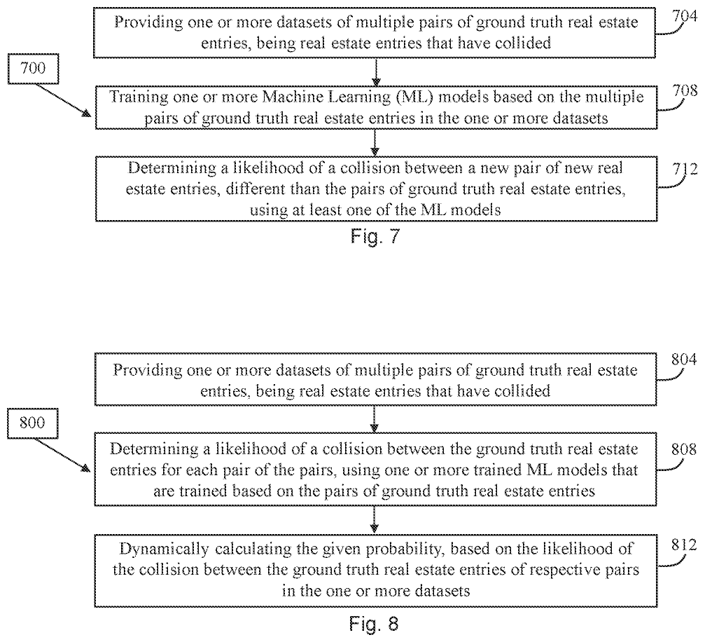

Turning to the sequence of operations 200, collision determination system 100 can be configured to provide one or more statistical distribution functions or machine learning (ML) models that are generated based on known collisions between ground truth real estate entries, as detailed further herein, inter alia with reference to FIGS. 5 and 7 (block 204).

Collision determination system 100 can also be configured to obtain: (a) resource information on resource features of one or more real estate resources for which the given real estate record and at least one of the other real estate records are possible successive events associated therewith; (b) given real estate record information on given record features in the given real estate record; and (c) other real estate record information on other record features in the other real estate records (block 208).

The resource features include at least: locations of the real estate resources, rental prices per unit area (e.g., rental prices per square foot) for the real estate resources, and sizes (e.g., square footage) of the real estate resources. In some cases, the resource features can include at least one or more of the following: intended use for the real estate resource (e.g., office use, industrial use, etc.), the entity or entities that own the real estate resource, a size of a building in which the real estate resource is located, a total number of floors in a building in which the real estate resource is located, the year in which a building in which the real estate resource is located was built or renovated, or an occupancy rate of a building in which the real estate resource is located.

Moreover, the record features (i.e., given record features, other record features) include at least: a rental price per unit area (e.g., rental price per square foot) for a real estate resource that is associated with the respective real estate record, and (b) a record start date in the respective real estate record.

In some cases, for a real estate record (i.e., given real estate record, other real estate record) that is a real estate lease, the record start date of the real estate lease can be one of: a lease effective date, a rent commencement date, a tenant move-in date, or a lease execution date. The lease effective date is the date upon which the rights and obligations of the landlord and the tenant under the real estate lease begin. The rent commencement date is the date upon which the tenant's responsibility to pay the landlord for use of the real estate resource associated with the real estate lease begins. The tenant move-in date is the date on which the tenant takes physical possession of the real estate resource that is associated with the real estate lease. The lease execution date is the date of execution of the real estate lease (i.e., the date on which the real estate lease is signed).

In some cases, for a real estate record (i.e., given real estate record, other real estate record) that is a real estate rental listing, the start date of the real estate rental listing can be one of: an availability date of the real estate resource that is the subject of the real estate rental listing or a publication date of the real estate rental listing. The availability date is the date on which the real estate resource is available to be rented.

In some cases, for a real estate record that is a real estate sales contract, the start date of the real estate sales contact can be a sales contract execution date, a sales commencement date, or a record date. The sales contract execution date is the date of execution of the real estate sales contract. The sales commencement date is the date on which the buyer of the real estate resource that is associated with the real estate sales contract is required to complete payment of the purchase price of the real estate resource. The record date is the date on which the sale of the real estate resource is publicly recorded.

In some cases, for a real estate record that is a real estate sales listing, the start date of the real estate sales listing can be one of: an availability date of the real estate resource that is the subject of the real estate sales listing or a publication date of the real estate sales listing. The availability date is the date on which the real estate resource is available to be purchased.

For a real estate record (e.g., given real estate record or other real estate record) that is a real estate rental record, as defined earlier herein, inter alia with reference to FIG. 1, the record features (e.g., given record features or other record features) of the real estate record also include a record end date in the real estate record. In some cases, the record end date can be an expiration date in the real estate record, being indicative of the date on which the real estate lease that is associated with the real estate record will end.

For a real estate record (e.g., given real estate record or other real estate record) that is a real estate lease, the record features in the real estate record also include a tenant identifier. The tenant identifier can be a name of the tenant that is renting or is subleasing the real estate resource that is associated with the real estate record or any other tenant identifier that is indicative of the tenant that is renting or is subleasing the real estate resource.

In some cases, the record features in a real estate record can also include one or more of the following: a size of the real estate resource (e.g., square footage of the real estate resource) that is associated with the real estate record, a market or a submarket of the real estate resource that is associated with the real estate record, an intended use of the real estate resource that is associated with the real estate record, a rent schedule or an equivalent parameter that is indicative of rent increases over the course of the real estate lease that is associated with the real estate record, additional information regarding the tenant or the tenant company that is renting the real estate resource that is associated with the real estate record, the entity or entities that own the real estate resource that is associated with the real estate record, a size of a building in which the real estate resource that is associated with the real estate record is located, a total number of floors in a building in which the real estate resource that is associated with the real estate record is located, the year in which a building in which the real estate resource that is associated with the real estate record is located was built or renovated, or an occupancy rate of a building in which the real estate resource that is associated with the real estate record is located.

In some cases, the record start dates in the other real estate records are later than the record start date in the given real estate record.

In some cases, the record start dates in the other real estate records are within a predefined date range subsequent to the record start date in the given real estate record, for example, later than the record start date in the given real estate record and earlier than or concurrent with a record end date in the given real estate record.

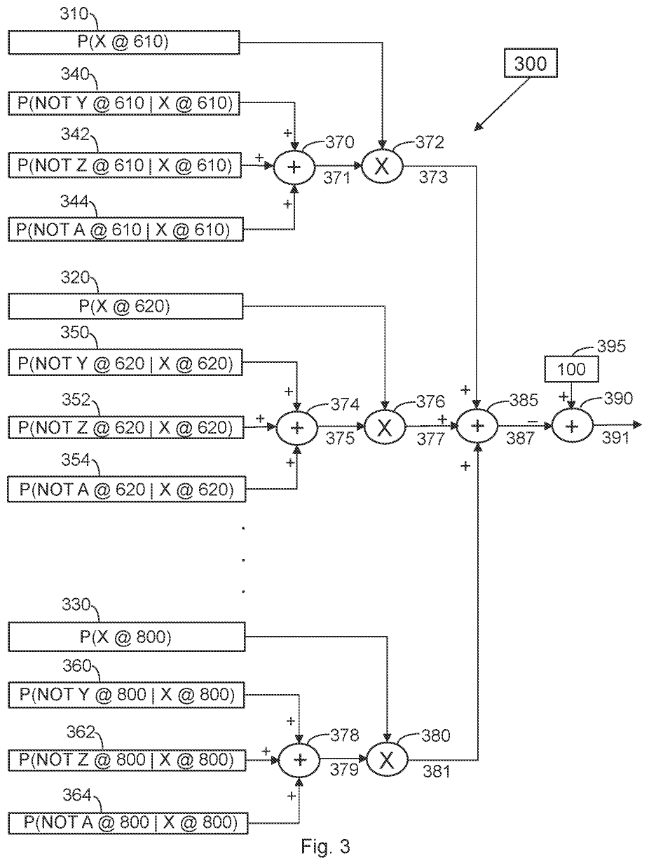

Returning to the sequence of operations 200, collision determination system 100 can be further configured to calculate a common real estate resource collision probability that the given real estate record and the at least one of the other real estate records are actual successive events associated with the common real estate resource, being one of the one or more real estate resources, the common real estate resource collision probability being calculated, as detailed further herein, inter alia with reference to FIGS. 3, 4, 6 and 7, based on the resource information, the given real estate record information, the other real estate record information, and one or more of the statistical distribution functions or ML models (block 212).

Collision determination system 100 can also be configured to compare the common real estate resource collision probability to a given probability (block 216).

In some cases, the given probability can be a predetermined probability. Alternatively, in some cases, the given probability can be dynamically calculated. One example of a sequence of operations for dynamically calculating the given probability is detailed further herein, inter alia with reference to FIG. 8.

Collision determination system 100 can be configured, upon the common real estate resource collision probability being greater than or equal to the given probability, to determine that the given real estate record and the at least one of the other real estate records are the actual successive events associated with the common real estate resource (block 220).

In some cases, in which: (a) the given real estate record is a given real estate lease or a given real estate rental listing that is associated with a given real estate lease, (b) each of the other real estate records is a respective other real estate lease or a respective other real estate rental listing, and (c) the record start dates of the other real estate records are later than the record start date of the given real estate record but earlier than or concurrent to a record end date of the given real estate record, a determination that the given real estate record and the at least one of the other real estate records are the actual successive events associated with the common real estate resource is indicative of a termination or a non-renewal of the given real estate lease. In some cases, in order for this determination to be indicative of the termination or the non-renewal of the given real estate lease, the start dates of the other real estate records are earlier than the record end date of the given real estate record by at least a predetermined threshold time (e.g., six months or a year for long-term real estate leases).

Attention is now drawn to FIG. 3, a schematic diagram illustrating a first example 300 of a sequence of operations for calculating a common real estate resource collision probability that a given real estate record and at least one other real estate record are actual successive events associated with a common real estate resource, in accordance with the presently disclosed subject matter.

In the first example 300 of FIG. 3, the given real estate record is record X. The other real estate records are records Y, Z and A. The real estate resources for which the given real estate record X and at least one of the other real estate records Y, Z and A are possible successive events include real estate resources 610, 620 and 800, and, optionally, additional real estate resources that are not illustrated in FIG. 3. It is to be noted that, in principle, the real estate resources can be one or more real estate resources.

For each real estate resource of the real estate resources (e.g., real estate resources 610, 620, . . . , 800) for which the given real estate record (e.g., record X) and at least one of the other real estate records (e.g., records Y, Z and A) are possible successive events, collision determination system 100 can be configured, in the example of FIG. 3, to determine a given record-resource probability (e.g., P(X)) that the given real estate record (e.g., record X) is associated with (i.e., collides with) the respective real estate resource. In FIG. 3, the given record-resource probability that the given real estate record X is associated with real estate resource 610, P(X @ 610), is determined in step 310; the given record-resource probability that the given real estate record X is associated with real estate resource 620, P(X @ 620), is determined in step 320; and the given record-resource probability that the given real estate record X is associated with real estate resource 800, P(X @ 800), is determined in step 330.

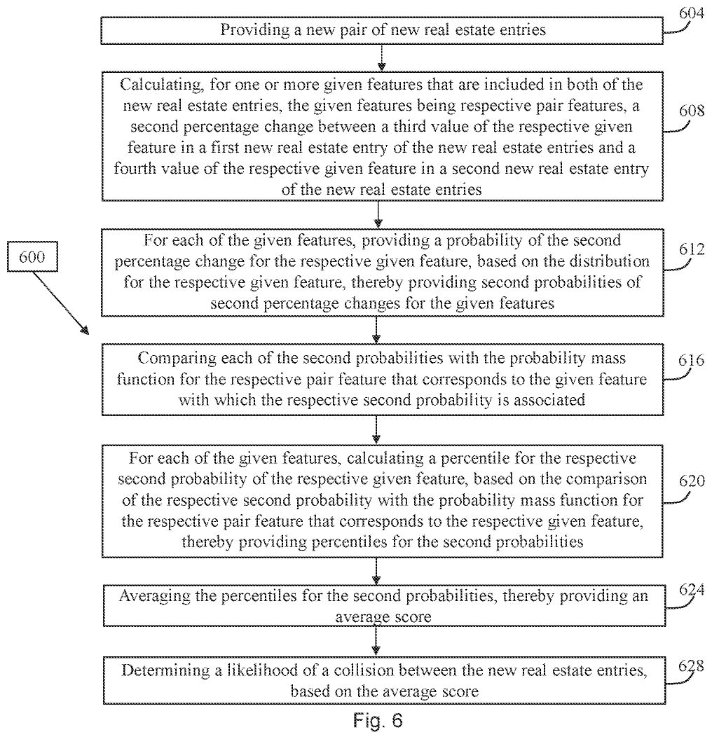

The given record-resource probability that is associated with each real estate resource of the real estate resources (e.g., 610, 620, . . . , 800) can be determined, utilizing at least one of the statistical distribution functions or ML models, based on record values of one or more of the record features in the given real estate record (e.g., record X) and resource values of one or more of the resource features that are associated with the respective real estate resource (e.g., 610, 620, . . . , or 800), as detailed further herein, inter alia with reference to FIGS. 6 and 7.

In some cases, as illustrated in FIG. 3, for each real estate resource of the real estate resources (e.g., real estate resources 610, 620, . . . , 800) for which the given real estate record (e.g., record X) and at least one of the other real estate records (e.g., records Y, Z and A) are possible successive events, collision determination system 100 can further be configured to determine, for each other real estate record of the other real estate records (e.g., records Y, Z and A), a conditional probability that the respective other real estate record (e.g., record Y, Z or A) is not associated with the respective real estate resource (e.g., real estate resource 610, 620, . . . , or 800), provided that the given real estate record (e.g., record X) is associated with the respective real estate resource (e.g., real estate resource 610, 620, . . . , or 800).

In FIG. 3, the conditional probability that the other real estate record Y is not associated with the real estate resource 610, provided that the given real estate record X is associated with the real estate resource 610, P(NOT Y @ 610|X @ 610), is determined in step 340; the conditional probability that the other real estate record Z is not associated with the real estate resource 610, provided that the given real estate record X is associated with the real estate resource 610, P(NOT Z @ 610|X @ 610), is determined in step 342; and the conditional probability that the other real estate record A is not associated with the real estate resource 610, provided that the given real estate record X is associated with the real estate resource 610, P(NOT A @ 610|X @ 610), is determined in step 344.

Moreover, in FIG. 3, the conditional probability that the other real estate record Y is not associated with the real estate resource 620, provided that the given real estate record X is associated with the real estate resource 620, P(NOT Y @ 620|X @ 620), is determined in step 350; the conditional probability that the other real estate record Z is not associated with the real estate resource 620, provided that the given real estate record X is associated with the real estate resource 620, P(NOT Z @ 620|X @ 620), is determined in step 352; and the conditional probability that the other real estate record A is not associated with the real estate resource 620, provided that the given real estate record X is associated with the real estate resource 620, P(NOT A @ 620|X @ 620), is determined in step 354.

In addition, in FIG. 3, the conditional probability that the other real estate record Y is not associated with the real estate resource 800, provided that the given real estate record X is associated with the real estate resource 800, P(NOT Y @ 800|X @ 800), is determined in step 360; the conditional probability that the other real estate record Z is not associated with the real estate resource 800, provided that the given real estate record X is associated with the real estate resource 800, P(NOT Z @ 800|X @ 800), is determined in step 362; and the conditional probability that the other real estate record A is not associated with the real estate resource 800, provided that the given real estate record X is associated with the real estate resource 800, P(NOT A @ 800|X @ 800), is determined in step 364.

A conditional probability that a respective other real estate record (e.g., record Y, Z, or A) is not associated with the respective real estate resource (e.g., real estate resource 610, 620, . . . , or 800), provided that the given real estate record (e.g., record X) is associated with the respective real estate resource (e.g., real estate resource 610, 620, . . . , or 800) can be determined, utilizing at least one of the statistical distribution functions or ML models, based on: (a) the given record-resource probability (e.g., P(X)) that the given real estate record (e.g., record X) is associated with the respective real estate resource (e.g., real estate resource 610, 620, . . . , or 800); (b) another record-resource probability (e.g., P(NOT Y), P(NOT Z), P(NOT A)) that the respective other real estate record (e.g., record Y, Z or A) is not associated with the respective real estate resource (e.g., real estate resource 610, 620, . . . , or 800); and a record—record probability that the given real estate record (e.g., record X) and the respective other real estate record (e.g., record Y, Z or A) are associated with a same real estate resource.

The another record-resource probability (e.g., P(NOT Y), P(NOT Z), P(NOT A)) that the respective other real estate record (e.g., record Y, Z or A) is not associated with the respective real estate resource (e.g., real estate resource 610, 620, . . . , or 800) can be determined, utilizing at least one of the statistical distribution functions or ML models, based on record values of one or more of the record features in the other real estate record (e.g., record Y, Z or A) and resource values of one or more of the resource features in the respective real estate resource (e.g., real estate resource 610, 620, . . . , or 800), as detailed further herein, inter alia with reference to FIGS. 6 and 7.

Moreover, the record-record probability can be determined, utilizing at least one of the statistical distribution functions or ML models, based on record values of one or more of the record features in the given real estate record (e.g., record X) and record values of one or more of the record features in the respective other real estate record (e.g., record Y, Z or A), as detailed further herein, inter alia with reference to FIGS. 6 and 7.

In some cases, as illustrated in FIG. 3, collision determination system 100 can be configured, based on the given record-resource probability that is determined for each real estate resource of the real estate resources (e.g., 610, 620, . . . , 800) and the conditional probabilities that are determined for each real estate resource of the real estate resources (e.g., 610, 620, . . . , 800), to calculate a non-collision probability that the given real estate record (e.g., record X) and none of the other real estate records (e.g., records Y, Z and A) are actual successive events associated with the common real estate resource.

In some cases, collision determination system 100 can be configured to calculate the non-collision probability as follows. For each real estate resource of the one or more real estate resources (e.g., 610, 620, . . . , 800), collision determination system 100 can be configured to calculate a product of the given record-resource probability (P(X)) that is determined for the respective real estate resource (e.g., 610, 620, . . . , or 800) and a sum of the conditional probabilities (e.g., P(NOT Y|X), P(NOT Z|X), P(NOT A|X)) that are determined for the respective real estate resource (e.g., 610, 620, . . . , or 800). The conditional probabilities that are determined for the respective real estate resource are summed, notwithstanding a possible overlap between the conditional probabilities, thereby generally resulting in the calculated sum of the conditional probabilities being greater than an actual sum of the conditional probabilities. As a result thereof, the calculated common real estate resource collision probability is generally less than the actual common real estate resource collision probability, thereby reducing a number of false positive determinations of collisions involving the given real estate record. However, since the calculated sum of the conditional probabilities can be greater than an actual sum of the conditional probabilities, in some cases, the calculated sum of the conditional probabilities can be greater than 100 percent. In such cases, the “sum” of the conditional probabilities can be capped at 100 percent.

In some cases, in which the common real estate resource is a specific real estate resource, the calculated product of the given record-resource probability (P(X)) that is determined for the specific real estate resource and the sum of the conditional probabilities (e.g., P(NOT Y|X), P(NOT Z|X), P(NOT A|X)) that are determined for the specific real estate resource can be the non-collision probability.

In some cases, in which a plurality of real estate resources (e.g., 610, 620, . . . , 800) are possibly associated with the given real estate record and at least one other real estate record, collision determination system 100 can be further configured to combine the calculated products for the plurality of real estate resources (e.g., 610, 620, . . . , 800) to determine the non-collision probability. In some cases, collision determination system 100 can be configured to combine the calculated products by adding the calculated products.

Attention is now redrawn to FIG. 3, which illustrates an example of a sequence of operations performed by the collision determination system 100 to determine the non-collision probability. A first combiner 370 can add the conditional probabilities 340, 342 and 344 that are determined for the real estate resource 610, resulting in a first sum of the conditional probabilities 371 for the real estate resource 610. If the first sum of the conditional probabilities 371 is greater than 100 percent, the “first sum” can be capped at a value of 100 percent (i.e., a value of 1). A first multiplier 372 can multiply the first sum of the conditional probabilities 371 by the given record-resource probability 310 that is determined for the real estate resource 610 to provide a first product 373 for the real estate resource 610.

Moreover, a second combiner 374 can add the conditional probabilities 350, 352 and 354 that are determined for the real estate resource 620, resulting in a second sum of the conditional probabilities 375 for the real estate resource 620. If the second sum of the conditional probabilities 375 is greater than 100 percent, the “second sum” can be capped at a value of 100 percent (i.e., a value of 1). A second multiplier 376 can multiply the second sum of the conditional probabilities 375 by the given record-resource probability 320 that is determined for the real estate resource 620 to provide a second product 377 for the real estate resource 620.

In addition, a third combiner 378 can add the conditional probabilities 360, 362 and 364 that are determined for the real estate resource 800, resulting in a third sum of the conditional probabilities 379 for the real estate resource 800. If the third sum of the conditional probabilities 379 is greater than 100 percent, the “third sum” can be capped at a value of 100 percent (i.e., a value of 1). A third multiplier 380 can multiply the third sum of the conditional probabilities 379 by the given record-resource probability 330 that is determined for the real estate resource 800 to provide a third product 381 for the real estate resource 800.

A fourth combiner 385 can be configured to add the first product 373, the second product 377, the third product 381, and any additional products for any additional real estate resources, if any, resulting in a non-collision probability 387 that the given real estate record (e.g., record X) and none of the other real estate records (e.g., records Y, Z and A) are actual successive events associated with the common real estate resource.

Collision determination system 100 can be configured to calculate the common real estate resource collision probability 391 by subtracting the non-collision probability 387 from a one-hundred percent probability 395, by using a fifth combiner 390.

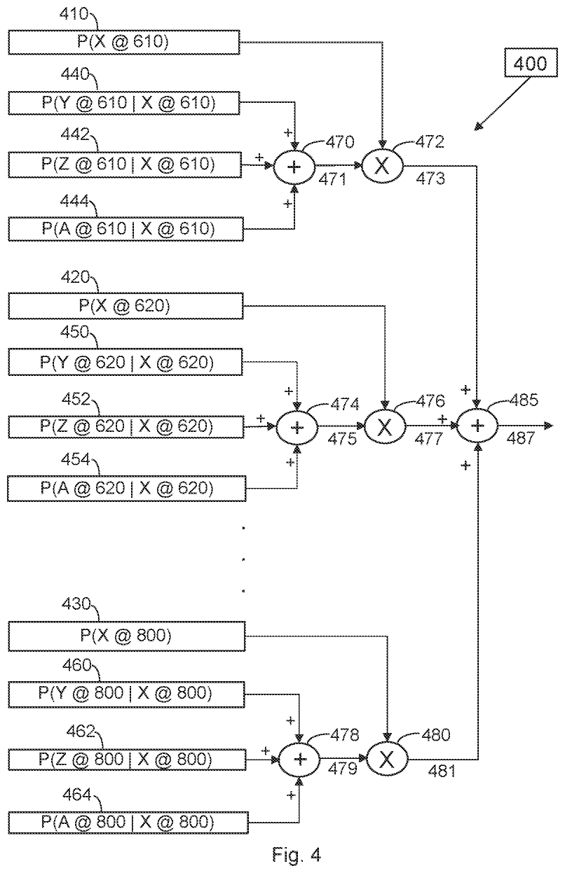

Attention is now drawn to FIG. 4, a schematic diagram illustrating a second example 400 of a sequence of operations for calculating a common real estate resource collision probability that a given real estate record and at least one other real estate record are actual successive events associated with a common real estate space, in accordance with the presently disclosed subject matter.

In the second example 400, as in the first example 300 in FIG. 3, the given real estate record is record X. The other real estate records are records Y, Z and A. The real estate resources for which the given real estate record X and at least one of the other real estate records Y, Z and A are possible successive events include real estate resources 610, 620 and 800, and, optionally, additional real estate resources that are not illustrated in FIG. 4. It is to be noted that, in principle, the real estate resources can be one or more real estate resources.

For each real estate resource of the real estate resources (e.g., real estate resources 610, 620, . . . , 800) for which the given real estate record (e.g., record X) and at least one of the other real estate records (e.g., records Y, Z and A) are possible successive events, collision determination system 100 can be configured, in the example of FIG. 4, to determine a given record-resource probability (e.g., P(X)) that the given real estate record (e.g., record X) is associated with (i.e., collides with) the respective real estate resource (real estate resource 610, 620, . . . , or 800). In FIG. 4, the given record-resource probability that the given real estate record X is associated with real estate resource 610, P(X @ 610), is determined in step 410; the given record-resource probability that the given real estate record X is associated with real estate resource 620, P(X @ 620), is determined in step 420; and the given record-resource probability that the given real estate record X is associated with real estate resource 800, P(X @ 800), is determined in step 430.

The given record-resource probability that is associated with each real estate resource of the real estate resources (e.g., 610, 620, . . . , 800) can be determined, utilizing at least one of the statistical distribution functions or ML models, based on record values of one or more of the record features in the given real estate record (e.g., record X) and resource values of one or more of the resource features that are associated with the respective real estate resource (e.g., 610, 620, . . . , or 800), as detailed further herein, inter alia with reference to FIGS. 6 and 7.

In some cases, as illustrated in FIG. 4, for each real estate resource of the real estate resources (e.g., real estate resources 610, 620, . . . , 800) for which the given real estate record (e.g., record X) and at least one of the other real estate records (e.g., records Y, Z and A) are possible successive events, collision determination system 100 can further be configured to determine, for each other real estate record of the other real estate records (e.g., records Y, Z and A), a conditional probability that the respective other real estate record (e.g., record Y, Z or A) is associated with the respective real estate resource (e.g., real estate resource 610, 620, . . . , or 800), provided that the given real estate record (e.g., record X) is associated with the respective real estate resource (e.g., real estate resource 610, 620, . . . , or 800).

In FIG. 4, the conditional probability that the other real estate record Y is associated with the real estate resource 610, provided that the given real estate record X is associated with the real estate resource 610, P(Y @ 610|X @ 610), is determined in step 440; the conditional probability that the other real estate record Z is associated with the real estate resource 610, provided that the given real estate record X is associated with the real estate resource 610, P(Z @ 610|X @ 610), is determined in step 442; and the conditional probability that the other real estate record A is associated with the real estate resource 610, provided that the given real estate record X is associated with the real estate resource 610, P(A @ 610|X @ 610), is determined in step 444.

Moreover, in FIG. 4, the conditional probability that the other real estate record Y is associated with the real estate resource 620, provided that the given real estate record X is associated with the real estate resource 620, P(Y @ 620|X @ 620), is determined in step 450; the conditional probability that the other real estate record Z is associated with the real estate resource 620, provided that the given real estate record X is associated with the real estate resource 620, P(Z @ 620|X @ 620), is determined in step 452; and the conditional probability that the other real estate record A is associated with the real estate resource 620, provided that the given real estate record X is associated with the real estate resource 620, P(A @ 620|X @ 620), is determined in step 454.

In addition, in FIG. 4, the conditional probability that the other real estate record Y is associated with the real estate resource 800, provided that the given real estate record X is associated with the real estate resource 800, P(Y @ 800|X @ 800), is determined in step 460; the conditional probability that the other real estate record Z is associated with the real estate resource 800, provided that the given real estate record X is associated with the real estate resource 800, P(Z @ 800|X @ 800), is determined in step 462; and the conditional probability that the other real estate record A is associated with the real estate resource 800, provided that the given real estate record X is associated with the real estate resource 800, P(A @ 800|X @ 800), is determined in step 464.

A conditional probability that a respective other real estate record (e.g., record Y, Z, or A) is associated with the respective real estate resource (e.g., real estate resource 610, 620, . . . , or 800), provided that the given real estate record (e.g., record X) is associated with the respective real estate resource (e.g., real estate resource 610, 620, . . . , or 800) can be determined, utilizing at least one of the statistical distribution functions or ML models, based on: (a) the given record-resource probability (e.g., P(X)) that the given real estate record (e.g., record X) is associated with the respective real estate resource (e.g., real estate resource 610, 620, . . . , or 800); (b) another record-resource probability (e.g., P(Y), P(Z), P(A)) that the respective other real estate record (e.g., record Y, Z or A) is associated with the respective real estate resource (e.g., real estate resource 610, 620, . . . , or 800); and a record-record probability that the given real estate record (e.g., record X) and the respective other real estate record (e.g., record Y, Z or A) are associated with a same real estate resource.

The another record-resource probability (e.g., P(Y), P(Z), P(A)) that the respective other real estate record (e.g., record Y, Z or A) is associated with the respective real estate resource (e.g., real estate resource 610, 620, . . . , or 800) can be determined, utilizing at least one of the statistical distribution functions or ML models, based on record values of one or more of the record features in the other real estate record (e.g., record Y, Z or A) and resource values of one or more of the resource features in the respective real estate resource (e.g., real estate resource 610, 620, . . . , or 800), as detailed further herein, inter alia with reference to FIGS. 6 and 7.

Moreover, the record-record probability can be determined, utilizing at least one of the statistical distribution functions or ML models, based on record values of one or more of the record features in the given real estate record (e.g., record X) and record values of one or more of the record features in the respective other real estate record (e.g., record Y, Z or A), as detailed further herein, inter alia with reference to FIGS. 6 and 7.

In some cases, as illustrated in FIG. 4, collision determination system 100 can be configured, based on the given record-resource probability that is determined for each real estate resource of the real estate resources (e.g., 610, 620, . . . , 800) and the conditional probabilities that are determined for each real estate resource of the real estate resources (e.g., 610, 620, . . . , 800), to calculate the common real estate resource collision probability.

In some cases, as illustrated in FIG. 4, collision determination system 100 can be configured to calculate the common real estate resource collision probability as follows. For each real estate resource of the one or more real estate resources (e.g., 610, 620, . . . , 800), collision determination system 100 can be configured to calculate a product of the given record-resource probability (P(X)) that is determined for the respective real estate resource (e.g., 610, 620, . . . , or 800) and a sum of the conditional probabilities (e.g., P(Y|X), P(Z|X), P(A|X)) that are determined for the respective real estate resource (e.g., 610, 620, . . . , or 800). The conditional probabilities that are determined for the respective real estate resource are summed, notwithstanding a possible overlap between the conditional probabilities, thereby generally resulting in the calculated sum of the conditional probabilities generally being greater than an actual sum of the conditional probabilities. If, as a result thereof, the calculated sum of the conditional probabilities is greater than 100 percent, the “sum” of the conditional probabilities can be capped at 100 percent.

In some cases, in which the common real estate resource is a specific real estate resource, the calculated product of the given record-resource probability (P(X)) that is determined for the specific real estate resource and the sum of the conditional probabilities (e.g., P(Y|X), P(Z|X), P(A|X)) that are determined for the specific real estate resource can be the common real estate resource collision probability.

In some cases, in which a plurality of real estate resources (e.g., 610, 620, . . . , 800) are possibly associated with the given real estate record and at least one other real estate record, collision determination system 100 can also be configured to combine the calculated products for the plurality of real estate resources (e.g., 610, 620, . . . , 800) to provide the common real estate resource collision probability. In some cases, collision determination system 100 can be configured to combine the calculated products by adding the calculated products.

To illustrate this, attention is redrawn to FIG. 4. A first combiner 470 can add the conditional probabilities 440, 442 and 444 that are determined for the real estate resource 610, resulting in a first sum of the conditional probabilities 471 for the real estate resource 610. If the first sum of the conditional probabilities 471 is greater than 100 percent, the “first sum” can be capped at a value of 100 percent (i.e., a value of 1). A first multiplier 472 can multiply the first sum of the conditional probabilities 471 by the given record-resource probability 410 that is determined for the real estate resource 610 to provide a first product 473 for the real estate resource 610.

Moreover, a second combiner 474 can add the conditional probabilities 450, 452 and 454 that are determined for the real estate resource 620, resulting in a second sum of the conditional probabilities 475 for the real estate resource 620. If the second sum of the conditional probabilities 475 is greater than 100 percent, the “second sum” can be capped at a value of 100 percent (i.e., a value of 1). A second multiplier 476 can multiply the second sum of the conditional probabilities 475 by the given record-resource probability 420 that is determined for the real estate resource 620 to provide a second product 477 for the real estate resource 620.

In addition, a third combiner 478 can add the conditional probabilities 460, 462 and 464 that are determined for the real estate resource 800, resulting in a third sum of the conditional probabilities 479 for the real estate resource 800. If the third sum of the conditional probabilities 479 is greater than 100 percent, the “third sum” can be capped at a value of 100 percent (i.e., a value of 1). A third multiplier 480 can multiply the third sum of the conditional probabilities 479 by the given record-resource probability 430 that is determined for the real estate resource 800 to provide a third product 481 for the real estate resource 800.

A fourth combiner 485 can be configured to add the first product 473, the second product 477, the third product 481, and any additional products for any additional real estate resources, if any, resulting in the common real estate resource collision probability 487.

Attention is now drawn to FIG. 5, a flowchart illustrating one example of a sequence of operations 500 for providing one or more statistical distribution functions for calculating the common real estate resource collision probability, in accordance with the presently disclosed subject matter.

In accordance with the presently disclosed subject matter, in some cases, collision determination system 100 can be configured to provide one or more datasets of multiple pairs of ground truth real estate entries, being real estate entries that have collided (block 504). In some cases, a respective pair of ground truth real estate entries can be a record-resource pair, being a respective real estate record (e.g., lease, listing, sales record, etc.) and the real estate resource (e.g., real estate space) with which the respective real estate record is associated (i.e., with which the respective real estate record has collided). Additionally, or alternatively, in some cases, a respective pair of ground truth real estate entries can be a record-record pair, being two real estate records that are known to have collided (i.e., one of the two real estate records directly continues the other of the two real estate records for a given real estate resource).

In some cases, a single dataset can be provided. The single dataset can include both record-resource pairs and record-record pairs.

Alternatively, in some cases, a plurality of datasets can be provided. In some cases, each dataset can include either record-resource pairs or record-record pairs. It is to be noted that any number of datasets can be provided, wherein any respective dataset of the datasets can include record-resource pairs, record-record pairs, or both.

Collision determination system 100 can also be configured, for each pair of the pairs of ground truth real estate entries in the one or more datasets, to calculate, for one or more features (e.g., rental price per unit area, etc.) that are included in both of the ground truth real estate entries of the respective pair, being pair features, a percentage change between a first value of the respective pair feature in a first ground truth real estate entry of the respective pair and a second value of the respective feature in a second ground truth real estate entry of the respective pair (block 508).

Collision determination system 100 can further be configured, for each dataset of the datasets, for each pair feature of the pair features in the respective dataset, to plot the percentage change that is calculated for the respective pair feature for each pair of the pairs of ground truth real estate entries in the respective dataset that include the respective pair feature, thereby providing a graph that includes plotted percentage changes for the respective pair feature (block 512).

In addition, collision determination system 100 can be configured, for each pair feature of the pair features in each dataset of the datasets, to (a) determine a given distribution type of multiple known distribution types that best fits the plotted percentage changes on the graph for the respective pair feature, thereby providing a distribution for the respective pair feature, and (b) calculating a probability mass function (being a statistical distribution function), based on the distribution for the respective pair feature, the probability mass function providing a probability of different percentage changes between a respective first value of the respective pair feature and a respective second value of the respective pair feature for a respective pair of ground truth real estate entries that include the respective pair feature (block 516).

In some cases, the multiple known distribution types can include one or more of: a normal distribution, a gamma distribution, or a poisson distribution. Additionally, or alternatively, in some cases, the given distribution type that best fits the plotted percentage changes on the graph for the respective pair feature is the known distribution type that receives a highest p-value.

Attention is now drawn to FIG. 6, a flowchart illustrating one example of a sequence of operations for calculating the likelihood of a collision between new real estate entries, based on the statistical distribution functions that are calculated in FIG. 5, in accordance with the presently disclosed subject matter.

In accordance with the presently disclosed subject matter, in some cases, collision determination system 100 can be configured to provide a new pair of new real estate entries (block 604). In some cases, the new pair can be a record-resource pair, as defined earlier herein, inter alia with reference to FIG. 5. Alternatively, in some cases, the new pair can be a record-record pair, as defined earlier herein, inter alia with reference to FIG. 5.

Collision determination system 100 can also be configured to calculate, for one or more given features that are included in both of the new real estate entries, the given features being respective pair features, a second percentage change between a third value of the respective given feature in a first new real estate entry of the new real estate entries and a fourth value of the respective given feature in a second new real estate entry of the new real estate entries (block 608).

For each of the given features, collision determination system 100 can further be configured to provide a probability of the second percentage change for the respective given feature, based on the distribution for the respective given feature that is determined as detailed earlier herein, inter alia with reference to FIG. 5, thereby providing second probabilities of second percentage changes for the given features (block 612).

Collision determination system 100 can be configured to compare each of the second probabilities with the probability mass function for the respective pair feature that corresponds to the given feature with which the respective second probability is associated (block 616).

For each of the given features, collision determination system 100 can be configured to calculate a percentile for the respective second probability of the respective given feature, based on the comparison of the respective second probability with the probability mass function for the respective pair feature that corresponds to the respective given feature, thereby providing percentiles for the second probabilities (block 620). In some cases, the percentiles for the second probabilities increase in accordance with the second probabilities themselves.

Collision determination system 100 can be further configured to average the percentiles for the second probabilities, thereby providing an average score (block 624).

Collision determination system 100 can be configured to determine a likelihood of a collision between the new real estate entries, based on the average score (block 628). In some cases, in which the percentiles for the second probabilities increase in accordance with the second probabilities themselves, a higher average score reflects a higher likelihood of a collision between the new real estate entries.

Attention is now drawn to FIG. 7, a flowchart illustrating one example of a sequence of operations for determining a likelihood of a collision between a new pair of new real estate entries, based on at least one Machine Learning (ML) model, in accordance with the presently disclosed subject matter.

In accordance with the presently disclosed subject matter, in some cases, collision determination system 100 can be configured to provide one or more datasets of multiple pairs of ground truth real estate entries, being real estate entries that have collided (block 704). In some cases, a respective pair of ground truth real estate entries can be a record-resource pair, being a respective real estate record (e.g., lease, listing, sales record, etc.) and the real estate resource (e.g., real estate space) with which the respective real estate record is associated (i.e., with which the respective real estate record has collided). Additionally, or alternatively, in some cases, a respective pair of ground truth real estate entries can be a record-record pair, being two real estate records that are known to have collided (i.e., one of the two real estate records directly continues the other of the two real estate records for a given real estate resource).

In some cases, a single dataset can be provided. The single dataset can include both record-resource pairs and record-record pairs.

Alternatively, in some cases, a plurality of datasets can be provided. In some cases, each dataset can include either record-resource pairs or record-record pairs. It is to be noted that any number of datasets can be provided, wherein any respective dataset of the datasets can include record-resource pairs, record-record pairs, or both.

Collision determination system 100 can be further configured to train one or more Machine Learning (ML) models based on the multiple pairs of ground truth real estate entries in the one or more datasets (block 708). A respective ML model of the ML models can be trained based on record-resource pairs in the datasets, record-record pairs in the datasets, or both.

Collision determination system 100 can also be configured to determine a likelihood of a collision between a new pair of new real estate entries, different than the pairs of ground truth real estate entries, using at least one of the ML models (block 712).

Attention is now drawn to FIG. 8, a flowchart illustrating one example of a sequence of operations for dynamically calculating a given probability, in accordance with the presently disclosed subject matter.

In accordance with the presently disclosed subject matter, and as detailed earlier herein, inter alia with reference to FIG. 2, a common real estate resource collision probability is compared to a given probability to determine whether the given real estate record and the at least one of the other real estate records are actual successive events associated with the common real estate resource. Moreover, as detailed earlier herein, inter alia with reference to FIG. 2, the given probability can be dynamically calculated.

In some cases, collision determination system 100 can be configured to dynamically calculate the given probability, based on a determination, using one or more trained ML models, of a likelihood of a collision between ground truth real estate entries that are known to have collided. For example, if the likelihood of a collision between a new pair of new real estate entries is greater than or equal to a given (e.g., lowest) likelihood of a collision between the ground truth real estate entries (that are known to have collided), it can be inferred that the given real estate record and the at least one of the other real estate records are actual successive events associated with the common real estate resource.

FIG. 8 illustrates one non-limiting example of a sequence of operations for dynamically calculating a given probability.

In accordance with FIG. 8, in some cases, collision determination system 100 can be configured to provide one or more datasets of multiple pairs of ground truth real estate entries, being real estate entries that have collided (block 804).

Collision determination system 100 can be further configured to determine a likelihood of a collision between the ground truth real estate entries for each pair of the pairs, using one or more trained ML models that are trained based on the pairs of ground truth real estate entries, as detailed earlier herein, inter alia with reference to FIG. 7 (block 808).

Collision determination system 100 can be configured to dynamically calculate the given probability, e.g. using at least one additional ML model on top of at least one of the trained ML models, based on the likelihood of the collision between the ground truth real estate entries of respective pairs in the one or more datasets (block 812).

Attention is now drawn to FIG. 9, a block diagram schematically illustrating one example of a collision prediction system 900, in accordance with the presently disclosed subject matter.

In accordance with the presently disclosed subject matter, collision prediction system 900 can comprise or be otherwise associated with a prediction data repository 910 (e.g. a database, a storage system, a memory including Read Only Memory—ROM, Random Access Memory—RAM, or any other type of memory, etc.) configured to store data. The data stored can include: (a) a data repository comprising a plurality of real estate records and (b) one or more Machine Learning (ML) models that are trained based on the real estate records. In some cases, prediction data repository 910 can be further configured to enable retrieval and/or update and/or deletion of the stored data. It is to be noted that in some cases, prediction data repository 910 can be distributed.

Collision prediction system 900 also comprises a prediction processing circuitry 920. Prediction processing circuitry 920 can be one or more processing units (e.g. central processing units), microprocessors, microcontrollers (e.g. microcontroller units (MCUs)) or any other computing devices or modules, including multiple and/or parallel and/or distributed processing units, which are adapted to independently or cooperatively process data for controlling relevant collision prediction system 900 resources and for enabling operations related to collision prediction system 900 resources.

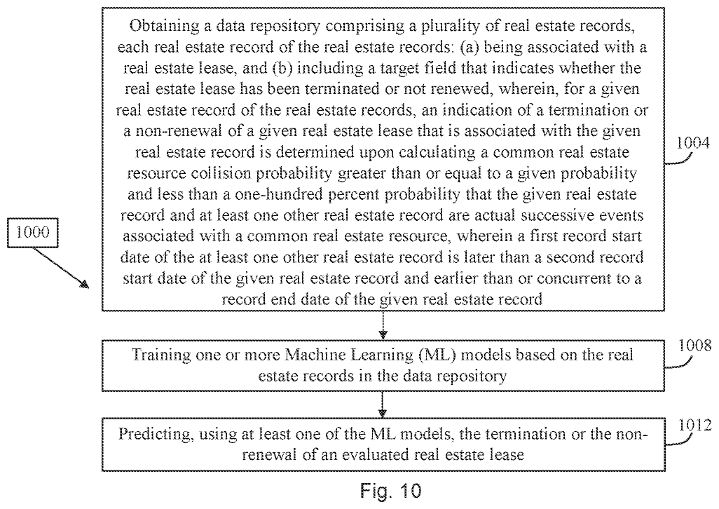

Prediction processing circuitry 920 can be configured to include a collision prediction module 930. Prediction processing circuitry 920 can be configured, e.g. using collision prediction module 930, to predict a termination or a non-renewal of an evaluated real estate lease, as detailed further herein, inter alia with reference to FIG. 10.

Attention is now drawn to FIG. 10, a flowchart illustrating one example of a sequence of operations 1000 performed by the collision prediction system 900, in accordance with the presently disclosed subject matter.

In accordance with the presently disclosed subject matter, collision prediction system 900 can be configured to obtain a data repository comprising a plurality of real estate records, each real estate record of the real estate records: (a) being associated with a real estate lease (i.e., a real estate lease or a real estate rental listing that is associated with a real estate lease), and (b) including a target field that indicates whether the real estate lease has been terminated or not renewed. For a given real estate record of the real estate records, an indication of a termination or a non-renewal of a given real estate lease that is associated with the given real estate record is determined upon calculating a common real estate resource collision probability greater than or equal to a given probability and less than a one-hundred percent probability that the given real estate record and at least one other real estate record are actual successive events associated with a common real estate resource, for example, as detailed earlier herein, inter alia with reference to FIGS. 2 to 4 and 6 to 8, wherein a first record start date of the at least one other real estate record is later than a second record start date of the given real estate record and earlier than or concurrent to a record end date of the given real estate record (block 1004). In some cases, the first record start date of the at least one other real estate record is earlier than the record end date of the given real estate record by at least a predetermined threshold time (e.g., six months or a year for long-term real estate leases).

Collision prediction system 1000 can also be configured to train one or more Machine Learning (ML) models based on the real estate records in the data repository (block 1008).

Collision prediction system 1000 can further be configured to predict, using at least one of the ML models, the termination or the non-renewal of an evaluated real estate lease (block 1012).

It is to be noted that, with reference to FIGS. 2 to 8 and 10, some of the blocks can be integrated into a consolidated block or can be broken down to a few blocks and/or other blocks may be added. Furthermore, in some cases, the blocks can be performed in a different order than described herein. It is to be further noted that some of the blocks are optional. It should be also noted that whilst the flow diagrams are described also with reference to the system elements that realize them, this is by no means binding, and the blocks can be performed by elements other than those described herein.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1. A method for determining that a given real estate record and at least one other real estate record of one or more other real estate records, other than the given real estate record, are actual successive events associated with a common real estate resource, the common real estate resource being one of one or more real estate resources for which the given real estate record and at least one of the other real estate records are possible successive events, the method comprising:
providing one or more statistical distribution functions or machine learning (ML) models, the statistical distribution functions or ML models being generated based on entry information that is included in multiple pairs of ground truth real estate entries;
obtaining: (a) resource information on resource features that are associated with the one or more real estate resources; (b) given real estate record information on given record features that are associated with the given real estate record; and (c) other real estate record information on other record features that are associated with the other real estate records;
calculating a common real estate resource collision probability that the given real estate record and the at least one other real estate record are the actual successive events associated with the common real estate resource, the common real estate resource collision probability being calculated based on the resource information, the given real estate record information, the other real estate record information, and one or more of the statistical distribution functions or ML models;
comparing the common real estate resource collision probability to a given probability; and
upon the common real estate resource collision probability being greater than or equal to the given probability, determining that the given real estate record and the at least one other real estate record are the actual successive events associated with the common real estate resource.

2. The method of claim 1, wherein a first start date of the given real estate record is earlier than second start dates of the other real estate records, and wherein the second start dates are within a predefined date range subsequent to the first start date.

3. The method of claim 2, wherein the given real estate record is associated with a given real estate lease;
wherein the other real estate records are associated with one or more other real estate leases;
wherein the second start dates are earlier than or concurrent to a record end date of the given real estate record, and wherein determining that the given real estate record and the at least one other real estate record are the actual successive events associated with the common real estate resource is indicative of a termination or a non-renewal of the given real estate lease.

4. The method of claim 3, wherein determining that the given real estate record and the at least one other real estate record are the actual successive events associated with the common real estate resource is indicative of the termination or the non-renewal of the given real estate lease upon a second start date associated with the at least one other real estate record being earlier than the record end date of the given real estate record by at least a predetermined threshold time.

5. The method of claim 1, wherein the common real estate resource collision probability is calculated as follows:
for each real estate resource of the one or more real estate resources:
(a) determining a record-resource probability that the given real estate record is associated with the respective real estate resource; and
(b) for each other real estate record of the other real estate records, determining a conditional probability that the respective other real estate record is not associated with the respective real estate resource, provided that the given real estate record is associated with the respective real estate resource, thereby providing one or more conditional probabilities that are associated with the other real estate records;
calculating a non-collision probability that the given real estate record and none of the other real estate records are the actual successive events associated with the common real estate resource, based on the record-resource probability and the conditional probabilities that are determined for each real estate resource of the one or more real estate resources; and
subtracting the non-collision probability from a one-hundred percent probability.

6. The method of claim 5, wherein the non-collision probability is calculated as follows:
for each real estate resource of the one or more real estate resources, calculating a product of the record-resource probability that is determined for the respective real estate resource and a sum of the conditional probabilities that are determined for the respective real estate resource, thereby providing one or more calculated products corresponding to the one or more real estate resources; and
if the one or more real estate resources are two or more real estate resources, combining the calculated products.

7. The method of claim 6, wherein the calculated products are combined by adding the calculated products.

8. The method of claim 1, wherein the given real estate record is a Commercial Real Estate (CRE) record, wherein the other real estate records are CRE records, and wherein the real estate resources are commercial real estate resources.

9. A method for predicting a termination or a non-renewal of an evaluated real estate lease, the method comprising:
obtaining a data repository comprising a plurality of real estate records, each real estate record of the real estate records: (a) being associated with a real estate lease, and (b) including a target field that indicates whether the real estate lease has been terminated or not renewed, wherein, for a given real estate record of the real estate records, an indication of a termination or a non-renewal of a given real estate lease that is associated with the given real estate record is determined according to the method of claim 4;
training one or more Machine Learning (ML) models based on the real estate records in the data repository; and
predicting, using at least one of the ML models, the termination or the non-renewal of the evaluated real estate lease.

10. The method of claim 9, wherein the evaluated real estate lease is a Commercial Real Estate (CRE) lease, and wherein the real estate records are CRE records.

11. A system for determining that a given real estate record and at least one other real estate record of one or more other real estate records, other than the given real estate record, are actual successive events associated with a common real estate resource, the common real estate resource being one of one or more real estate resources for which the given real estate record and at least one of the other real estate records are possible successive events, the system comprising a processing circuitry configured to:
provide one or more statistical distribution functions or machine learning (ML) models, the statistical distribution functions or ML models being generated based on entry information that is included in multiple pairs of ground truth real estate entries;
obtain: (a) resource information on resource features that are associated with the one or more real estate resources; (b) given real estate record information on given record features that are associated with the given real estate record; and (c) other real estate record information on other record features that are associated with the other real estate records;
calculate a common real estate resource collision probability that the given real estate record and the at least one other real estate record are the actual successive events associated with the common real estate resource, the common real estate resource collision probability being calculated based on the resource information, the given real estate record information, the other real estate record information, and one or more of the statistical distribution functions or ML models;
compare the common real estate resource collision probability to a given probability; and
upon the common real estate resource collision probability being greater than or equal to the given probability, determine that the given real estate record and the at least one other real estate record are the actual successive events associated with the common real estate resource.

12. The system of claim 11, wherein a first start date of the given real estate record is earlier than second start dates of the other real estate records, and wherein the second start dates are within a predefined date range subsequent to the first start date.

13. The system of claim 12, wherein the given real estate record is associated with a given real estate lease;
wherein the other real estate records are associated with one or more other real estate leases;
wherein the second start dates are earlier than or concurrent to a record end date of the given real estate record, and wherein determining that the given real estate record and the at least one other real estate record are the actual successive events associated with the common real estate resource is indicative of a termination or a non-renewal of the given real estate lease.

14. The system of claim 13, wherein determining that the given real estate record and the at least one other real estate record are the actual successive events associated with the common real estate resource is indicative of the termination or the non-renewal of the given real estate lease upon a second start date associated with the at least one other real estate record being earlier than the record end date of the given real estate record by at least a predetermined threshold time.

15. The system of claim 11, wherein the processing circuitry is configured to calculate the common real estate resource collision probability as follows:
for each real estate resource of the one or more real estate resources, the processing circuitry is configured to:
(c) determine a record-resource probability that the given real estate record is associated with the respective real estate resource; and
(d) for each other real estate record of the other real estate records, determine a conditional probability that the respective other real estate record is not associated with the respective real estate resource, provided that the given real estate record is associated with the respective real estate resource, thereby providing one or more conditional probabilities that are associated with the other real estate records;
calculate a non-collision probability that the given real estate record and none of the other real estate records are the actual successive events associated with the common real estate resource, based on the record-resource probability and the conditional probabilities that are determined for each real estate resource of the one or more real estate resources; and
subtract the non-collision probability from a one-hundred percent probability.

16. The system of claim 15, wherein the processing circuitry is configured to calculate the non-collision probability as follows:
for each real estate resource of the one or more real estate resources, the processing circuitry is configured to calculate a product of the record-resource probability that is determined for the respective real estate resource and a sum of the conditional probabilities that are determined for the respective real estate resource, thereby providing one or more calculated products corresponding to the one or more real estate resources; and
if the one or more real estate resources are two or more real estate resources, the processing circuitry is configured to combine the calculated products.

17. The system of claim 16, wherein the processing circuitry is configured to combine the calculated products by adding the calculated products.

18. The system of claim 11, wherein the given real estate record is a Commercial Real Estate (CRE) record, wherein the other real estate records are CRE records, and wherein the real estate resources are commercial real estate resources.

19. A system for predicting a termination or a non-renewal of an evaluated real estate lease, the system comprising a processing circuitry configured to:
obtain a data repository comprising a plurality of real estate records, each real estate record of the real estate records: (a) being associated with a real estate lease, and (b) including a target field that indicates whether the real estate lease has been terminated or not renewed, wherein, for a given real estate record of the real estate records, an indication of a termination or a non-renewal of a given real estate lease that is associated with the given real estate record is determined according to the system of claim 14;
train one or more Machine Learning (ML) models based on the real estate records in the data repository; and
predict, using at least one of the ML models, the termination or the non-renewal of the evaluated real estate lease.

20. A non-transitory computer readable storage medium having computer readable program code embodied therewith, the computer readable program code, executable by a processing circuitry of a computer to perform a method for determining that a given real estate record and at least one other real estate record of one or more other real estate records, other than the given real estate record, are actual successive events associated with a common real estate resource, the common real estate resource being one of one or more real estate resources for which the given real estate record and at least one of the other real estate records are possible successive events, the method comprising:
providing one or more statistical distribution functions or machine learning (ML) models, the statistical distribution functions or ML models being generated based on entry information that is included in multiple pairs of ground truth real estate entries;
obtaining: (a) resource information on resource features that are associated with the one or more real estate resources; (b) given real estate record information on given record features that are associated with the given real estate record; and (c) other real estate record information on other record features that are associated with the other real estate records;
calculating a common real estate resource collision probability that the given real estate record and the at least one other real estate record are the actual successive events associated with the common real estate resource, the common real estate resource collision probability being calculated based on the resource information, the given real estate record information, the other real estate record information, and one or more of the statistical distribution functions or ML models;
comparing the common real estate resource collision probability to a given probability; and
upon the common real estate resource collision probability being greater than or equal to the given probability, determining that the given real estate record and the at least one other real estate record are the actual successive events associated with the common real estate resource.
